(19) United States
(12) Patent Application Publication
(10) Pub. No.: US 2007/0160143 A1
(43) Pub. Date: Jul. 12, 2007

(54) Motion vector compression method, video encoder, and video decoder using the method

(75) Inventor: Kyo-hyuk Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/646,264

(22) Filed: Dec. 28, 2006

Related U.S. Application Data
(60) Provisional application No. 60/758,225, filed on Jan. 12, 2006.

(30) Foreign Application Priority Data
May 11, 2006 (KR) 10-2006-0042628

(51) Int. Cl. H04N 11/04; H04N 11/02

(52) U.S. Cl. 375/240.15; 375/240.16

(57) ABSTRACT

Provided are a method and apparatus for increasing the compression efficiency of a motion vector by efficiently predicting a motion vector of a frame that is located in a current temporal level of multiple temporal levels using a motion vector of a frame that is located in a next temporal level. The method includes selecting a second frame that exists in a low temporal level of a first frame and is nearest to the first frame, where the first frame exists in a current temporal level of the multiple temporal levels; generating a prediction motion vector for the first frame from a motion vector of the second frame; and subtracting the generated prediction motion vector from the motion vector of the first frame.

### CROSS-REFERENCE TO RELATED APPLICATION

This application claims priority from Korean Patent Application No. 10-2006-0042628 filed on May 11, 2006 in the Korean Intellectual Property Office and U.S. Provisional Patent Application No. 60/758,225 filed on Jan. 12, 2006, the disclosures of which are incorporated herein in their entirety by reference.

### BACKGROUND OF THE INVENTION

1. Field of the Invention

Apparatuses and methods consistent with the present invention relate to a video compression method and, more particularly, to a method and apparatus for increasing the compression efficiency of a motion vector by efficiently predicting a motion vector of a frame located in a current temporal level using a motion vector of a frame located in a next temporal level.

2. Description of the Related Art

With the development of information technologies, including the Internet, there have been increasing multimedia services containing various kinds of information such as text, video, and audio. Multimedia data is usually large and requires large capacity storage media and a wide bandwidth for transmission. Accordingly, a compression coding method is required for transmitting multimedia data.

A basic principle of data compression is removing redundancy. Data can be compressed by removing spatial redundancy in which the same color or object is repeated in an image, temporal redundancy in which there is little change between adjacent frames in a moving image or the same sound is repeated in audio, or psychovisual redundancy which takes into account human eyesight and its limited perception of high frequency. In general video coding, temporal redundancy is removed by motion estimation and compensation, and spatial redundancy is removed by transform coding.

To transmit multimedia after the data redundancy is removed, transmission media are required, wherein the performances of which differ. Presently used transmission media have diverse transmission speeds. For example, an ultrahigh-speed communication network can transmit several tens of megabits of data per second, and a mobile communication network has a transmission speed of 384 kilobits per second. Scalable video coding method is most suitable for such an environment in order to support the transmission media in such a transmission environment and to transmit multimedia with a transmission rate suitable for the transmission environment.

The working draft of the scalable video coding (SVC) is provided by Joint Video Team (JVT) which is a video experts group of the International Organization for Standardization/International Electrotechnical Commission (ISO/IEC) and International Telecommunication Union (ITU).

In the scalable video coding draft (hereinafter referred to as “the SVC draft”), multiple temporal decomposition based on the existing H.264 has been adopted as a method of implementing temporal scalability.

FIG. 1 illustrates an example of a multiple temporal decomposition. Here, a white rectangle means a low frequency frame and a black rectangle means a high frequency frame.

For example, in a temporal level 0, one frame is transformed into a high frequency frame with reference to the other frame of two frames having the farthest distance from the to-be-transformed frame. In a temporal level 1, a frame (picture order count POC=4) located in the center is transformed into a high frequency frame with reference to two frames (POC=0 and 4). As the temporal level increases, a high frequency frame is additionally generated in order to re-double a frame ratio. The process is repeatedly performed until all frames except for one low frequency frame (POC=0) are transformed into high frequency frames. In the example of FIG. 1, if one group of pictures (GOP) consists of 8 frames, the temporal decomposition is performed until one low frequency frame and 7 high frequency frames are generated.

The temporal decomposition is performed in a video encoder layer. On a video decoder side, a temporal composition is performed to reconstruct an original frame using the one low frequency frame and 7 high frequency frames. The temporal composition is performed from a low temporal level to a high temporal level like the temporal decomposition. That is, a high frequency frame (picture order count POC=4) is reconstructed to a low frequency frame with reference to two frames (POC=0 and 4). The process, which is performed to the final temporal level, is repeatedly performed until all high frequency frames are reconstructed to low frequency frames.

In temporal scalability, the generated low frequency frame and 7 high frequency frames may be not transmitted to the video decoder. For example, only one low frequency frame in a video streaming server and 3 high frequency frames (POC=2, 4, and 6) generated in temporal level 1 or 2 can be transmitted to the video decoder. Since the video decoder may reconstruct four lower frequency frames by performing the temporal composition up to the second temporal level, a video sequence of a half frame ratio can be obtained with comparison to an original video sequence that consists of 8 frames.

To generate a high frequency frame in the temporal decomposition, and to reconstruct a low frequency frame in the temporal composition, a motion vector that shows a motion relation with a reference frame must be obtained. Because the motion vector is included in the bitstream and is transmitted to the video decoder layer with encoded frames, it is important to efficiently compress the motion vector.

Motion vectors located in a similar temporal position (or picture order count POC) are likely to be similar to each other. For example, a motion vector 2 and a motion vector 3 may be quite similar to a motion vector 1 of a next temporal level. Accordingly, a coding method considering this correlation is disclosed in the current SVC working draft. The motion vectors 2 and 3 are predicted from the motion vector 1 of the corresponding low (lower) temporal level.

The high frequency frames do not always use bi-directional reference, as illustrated in FIG. 1. In fact, high frequency frames select and use the most profitable reference of a forward-direction reference (in the case of referring to a previous frame), a backward-direction reference (in the case of referring to a next frame), and a bi-direction reference (in the case of referring to both a previous frame and a next frame).

As illustrated in FIG. 2, various reference methods may be used in the temporal decomposition. According to the current SVC working draft, however, if a motion vector of the corresponding low temporal level does not exist, the corresponding motion vector is independently encoded without referring to another temporal level. If a motion vector of a low temporal level corresponding to motion vectors 23 and 24 of a frame 22, i.e., a backward motion vector of a frame 21, does not exist, the motion vectors 23 and 24 are encoded without a prediction between levels, which is not efficient.

### SUMMARY OF THE INVENTION

In view of the above, it is an aspect of the present invention to provide a method and apparatus for efficiently compressing a motion vector of a current temporal level when a motion vector of a corresponding low temporal level does not exist.

This and other aspects, features and advantages, of the present invention will become clear to those skilled in the art upon review of the following description, attached drawings and appended claims.

According to an aspect of the present invention, there is provided a method of compressing a motion vector in a temporal decomposition having multiple temporal levels, the method including selecting a second frame that exists in a low temporal level of a first frame, which exists in a current temporal level of the multiple temporal levels, and is nearest to the first frame; generating a prediction motion vector for the first frame from a motion vector of the second frame; and subtracting the generated prediction motion vector from the motion vector of the first frame.

According to another aspect of the present invention, there is provided a method of compressing a motion vector in a temporal composition having multiple temporal levels, the method including extracting motion data on a first frame that exists in the current temporal level of the multiple temporal levels from an input bitstream; selecting a second frame that exists in a low temporal level of the first frame and is nearest to the first frame; generating a prediction motion vector for the first frame from a motion vector of the second frame; and adding the generated prediction motion vector to the motion data.

According to an aspect of the present invention, there is provided an apparatus for compressing a motion vector in a temporal decomposition having multiple temporal levels, the apparatus including means that selects a second frame which exists in a low temporal level of a first frame, which exists in a current temporal level of the multiple temporal levels, and is nearest to the first frame; means that generates a prediction motion vector for the first frame from a motion vector of the second frame; and means that subtracts the generated prediction motion vector from the motion vector of the first frame.

According to still another aspect of the present invention, there is provided an apparatus for compressing a motion vector in a temporal composition having multiple temporal levels, the apparatus including means that extracts motion data on a first frame which exists in the current temporal level of the multiple temporal levels from an input bitstream; means that selects a second frame which exists in a low temporal level of the first frame and is nearest to the first frame; means that generates a prediction motion vector for the first frame from a motion vector of the second frame; and means that adds the generated prediction motion vector to the motion data.

### BRIEF DESCRIPTION OF THE DRAWINGS

The above and other aspects of the present invention will become apparent by describing in detail exemplary embodiments thereof with reference to the attached drawings, in which:

FIG. 1 illustrates an example of a multiple temporal decomposition;

FIG. 2 is a view of a case where a motion vector corresponding to a lower temporal level does not exist in a multiple temporal decomposition;

FIG. 3 is a conceptual view of motion vector prediction;

FIG. 4 illustrates a concept of using inverse motion vector prediction according to an exemplary embodiment of the present invention;

FIG. 5 illustrates a case where both a current frame and a base frame have a bi-direction motion vector and a POC difference is negative;

FIG. 6 illustrates a case where both a current frame and a base frame have a bi-directional motion vector and a POC difference is positive;

FIG. 7 illustrates a case where a base frame has only a backward motion vector;

FIG. 8 illustrates a case where a base frame has only a forward motion vector;

FIG. 9 is a view explaining an area corresponding to a current frame and a base frame;

FIG. 10 is a view explaining a method of determining a base frame motion vector;

FIG. 11 is a block diagram illustrating a construction of a video encoder according to an exemplary embodiment of the present invention; and

FIG. 12 is a block diagram illustrating a construction of a video decoder according to an exemplary embodiment of the present invention.

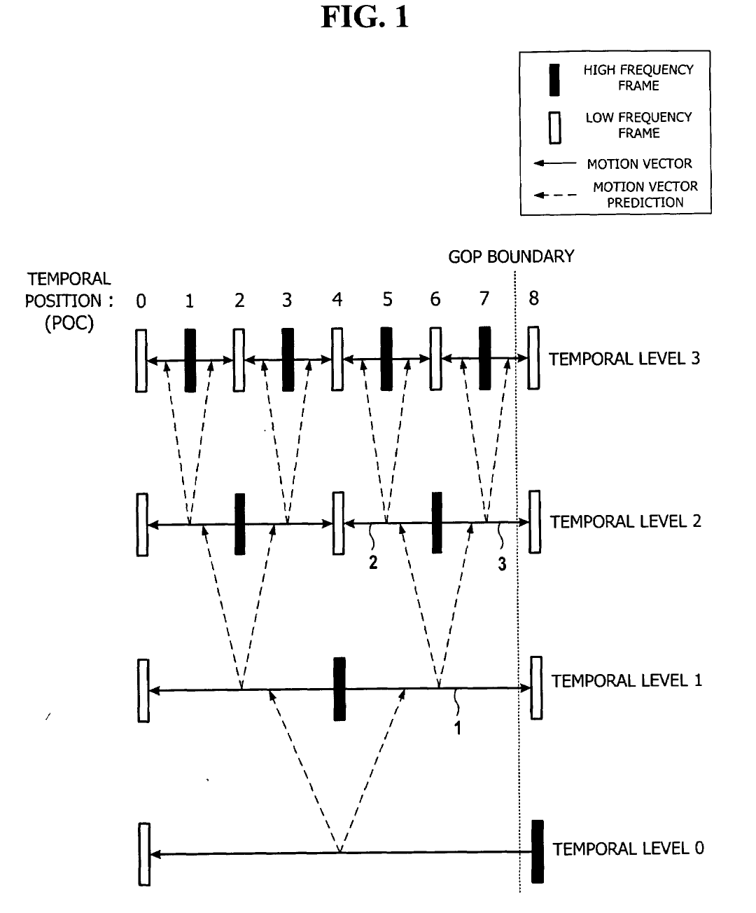

### DETAILED DESCRIPTION OF EXEMPLARY EMBODIMENTS OF THE INVENTION

Advantages and features of the aspects of the present invention and methods of accomplishing the same may be understood more readily by reference to the following detailed description of exemplary embodiments and the accompanying drawings. The aspects of the present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims.

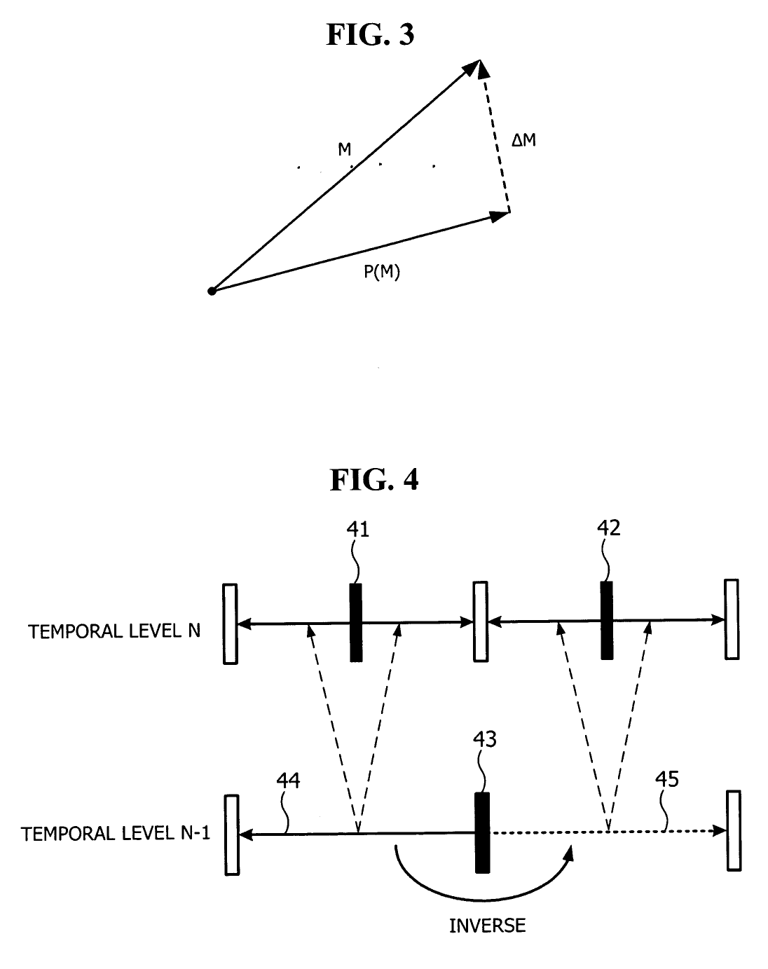

A motion vector prediction provides motion vector prediction in which a motion vector is compressively displayed using information that can be obtained by a video encoder and a video decoder. FIG. 3 is a conceptual view of the motion vector prediction. When a motion vector M is displayed as a difference ΔM between a prediction value P(M) of M (or a prediction motion vector of M) and M, less bits are consumed. The consumption of bits is reduced as the prediction value P(M) becomes similar to the motion vector M.

When the P(M) replaces M (if M is not obtained), the amount of bits consumed by M is 0. The quality of a video reconstructed in the video decoder may deteriorate due to the difference between M and P(M).

In an aspect of the present invention, the motion vector prediction not only means that the obtained motion vector is displayed as a difference between the obtained motion vector and the prediction motion vector, but also that the prediction value replaces the motion vector.

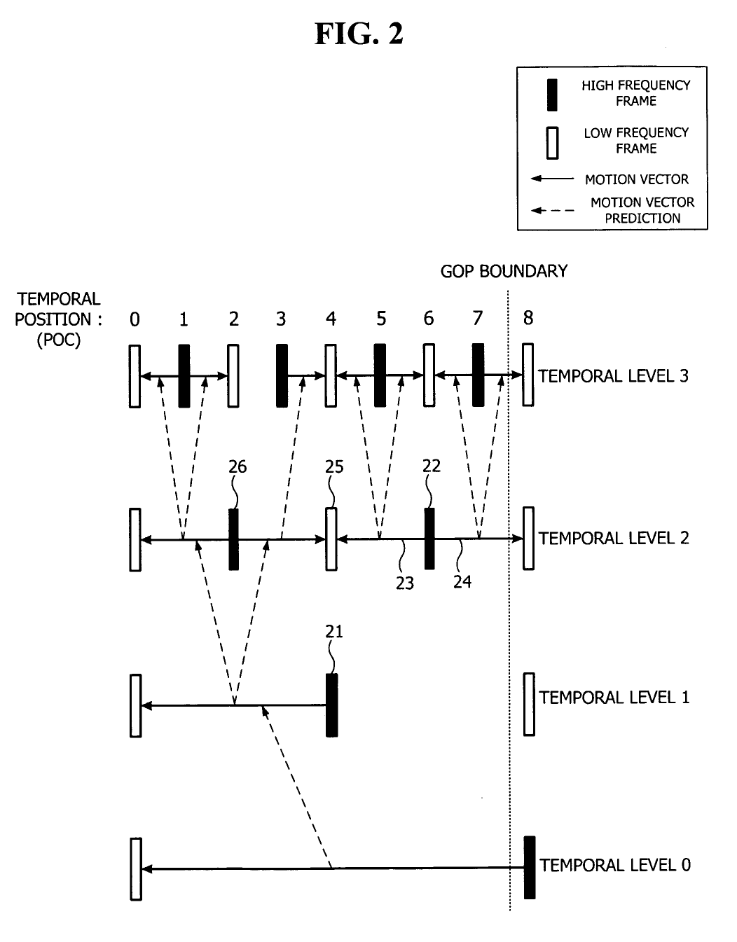

For the motion vector prediction, a current temporal level frame in which the corresponding low temporal level frame (hereinafter, referred to as “base frame”) does not exist is defined as an unsynchronized frame. In FIG. 2, a frame 25 has a base frame 21 having a same POC but a frame 22 has no base frame; accordingly, the frame 22 is defined as an unsynchronized frame.

Selecting a Base Frame

FIG. 2 illustrates a method of selecting a lower layer frame referred to for predicting a motion vector of an unsynchronized frame according to an exemplary embodiment of the present invention. The unsynchronized frame has no corresponding lower layer frame; therefore, selecting a frame having the type of conditions, of several lower layer frames, as a base frame is problematic.

A base frame is selected based on whether three conditions are satisfied: (1) a frame is a high frequency frame that exists in the highest temporal level of low temporal levels; (2) a frame has a smallest difference of POC with the current unsynchronized frame; and (3) a frame exists in the same GOP where the current unsynchronized frame exists.

In the first condition, the reason why only frames that exist in the highest temporal level are subject to the base frame is because the reference lengths of motion vectors of these frames is the shortest. If the reference length is long, the difference is too big to predict a motion vector of the unsynchronized frame. The reason why a frame must be a high frequency frame is because a motion vector may be predicted only when a base frame has a motion vector.

The second condition is for minimizing a temporal distance between the current unsynchronized frame and the base frame. Frames having a small temporal distance are likely to have more similar motion vectors. If two or more frames having a same POC difference exist in second condition, a frame having a smaller POC of the frames may be selected as the base frame.

The third condition requires that a frame exist in the same GOP where the current unsynchronized frame is located, because an encoding process may be delayed when referring to low temporal levels that are not in the same GOP. Accordingly, the third condition may be omitted in the case where the delay is not a problem.

In FIG. 2, a process of selecting a base frame of the unsynchronized frame 22 is as follows. Because the frame 22 exists in temporal level 2, a high frequency frame that satisfies conditions 1 through 3 is a frame 21. If the base frame 21 that has a smaller POC than the current frame 22 has a backward motion vector, the backward motion vector may be most suitably used to predict a motion vector of the current frame 22. However, the motion vector prediction is not used in the current frame 22 in the conventional SVC working draft because the base frame 21 has only a forward motion vector.

An aspect of the present invention provides a method of using an inverse-motion vector of a base frame to a motion vector prediction of a current frame (which is superior to the conventional concept) even if the base frame has no corresponding motion vector. As illustrated in FIG. 4, a frame 41 of the current temporal level (temporal level N) is used to predict a motion vector because a motion vector (a forward motion vector 44) corresponding to a base frame 43 exists. A frame 42 makes a virtual backward vector 45 by reversing the forward motion vector 44 and uses the virtual motion vector to the motion vector prediction because a motion vector (a backward motion vector) corresponding to the base frame 43 does not exist.

Calculating a Prediction Motion Vector

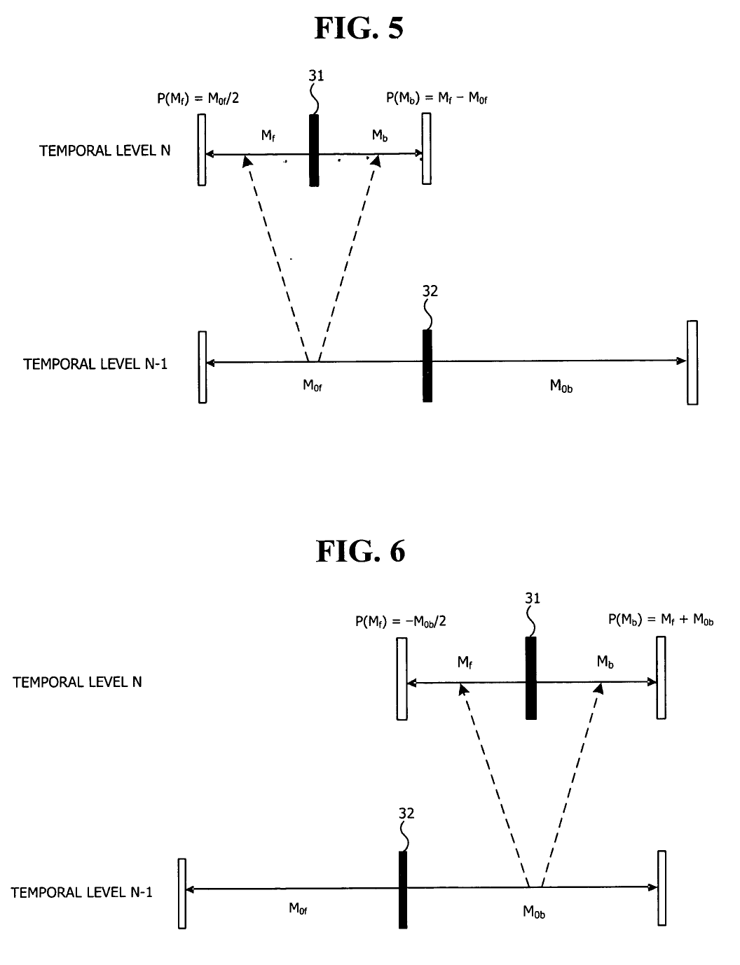

FIGS. 5 through 8 illustrate a detailed example of calculating a prediction motion vector P(M). When a result of subtracting POC of a base frame from POC of a current frame (hereinafter, referred to as “POC difference”) is negative, a forward motion vector M_{0f} is selected. If the result is positive, a backward motion vector M_{0b} is selected. If a to-be-selected motion vector does not exit, an existing backward motion vector is used.

FIG. 5 illustrates a case where both a current frame 31 and a base frame 32 have a bi-direction motion vector and a POC difference is negative. In this case, motion vectors M_{f} and M_{b} are predicted from a forward motion vector M_{0f} of the base frame 32, which results in a prediction motion vector P(M_{f}) of the forward motion vector M_{f} and a prediction motion vector P(M_{b}) of the forward motion vector M_{b}.

Objects generally move in a certain direction at a certain speed. Especially, the nature can be shown in a case where a background constantly moves or where a specific object is observed for a short time. Accordingly, it can be presumed that M_{f}−M_{b} is similar to M_{0f}. In an actual situation, M_{f} and M_{b} of which direction is opposed to each other are likely to have a similar modulus, which is because the speed of the moving object does not change much in a short period. Accordingly, P(M_{f}) and P(M_{b}) can be defined by Equation 1:

P(M_{f})=M_{0f}/2

P(M_{b})=M_{f}−M_{0f} (1)

In Equation 1, M_{f} is predicted using M_{0f}, and M_{b} is predicted using M_{f} and M_{0f}. There may be a case where the current frame 31 predicts only one direction, i.e., the current frame has only one of M_{f} and M_{b} because a video codec may select the most suitable one of forward, backward, and bi-directional references according to a compression efficiency.

When the current frame has only a forward reference, only the first formula of Equation 1 is used. If the current frame has only a backward reference, i.e., there is only M_{b} and no M_{f}, a second formula of Equation 1 cannot be used. In this case, P(M_{b}) can be defined by Equation 2 using the presumption that M_{f} may be similar to −M_{b}.

P(M_{b})=M_{f}−M_{0f}=−M_{b}−M_{0f} (2)

A difference of M_{b} and a prediction value of P(M_{b}) may be 2×M_{b}+M_{f}.

FIG. 6 illustrates a case where both a current frame and a base frame have bi-directional motion vectors and a POC difference is positive. Motion vectors M_{f} and M_{b} of the current frame 31 are predicted from M_{0b} of the current frame 31, which results in a prediction motion vector P(M_{f}) of the forward motion vector M_{f} and a prediction motion vector P(M_{b}) of the forward motion vector M_{b}.

Accordingly, P(Mf) and P(Mb) can be defined by Equation 3:

P(M_{f})=−M_{0b}/2

P(M_{b})=M_{f}+M_{0b} (3)

In Equation 3, M_{f} is predicted using M_{0b}, and M_{b} is predicted using M_{f} and M_{0b}. If the current frame 31 has only a backward reference, i.e., there is only M_{b} and no M_{f}, a second formula in Equation 3 cannot be used. In this case, P(M_{b}) can be defined by Equation 4:

P(M_{b})=M_{f}+M_{0b}=−M_{b}+M_{0b} (4)

There may be a case where the base frame 32 has one directional motion vector unlike exemplary embodiments of FIGS. 5 and 6.

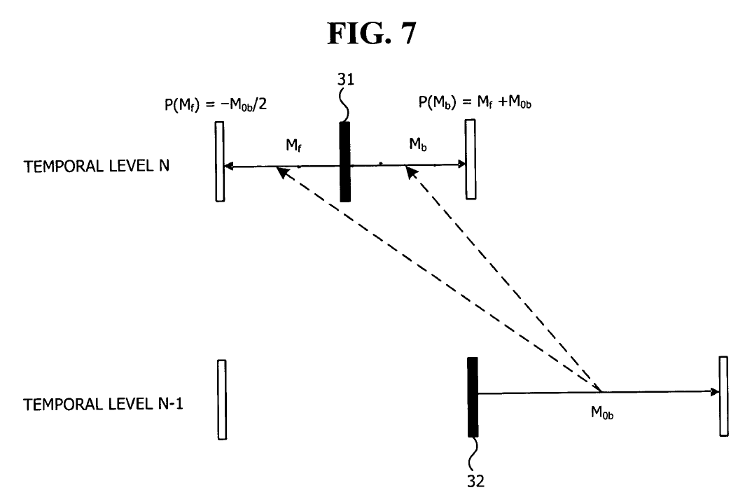

FIG. 7 illustrates a case where a base frame has only a backward motion vector M_{0b}. Prediction motion vectors P(M_{f}) and P(M_{b}) corresponding to M_{f} and M_{b} of the current frame 31 can be obtained by Equation 3.

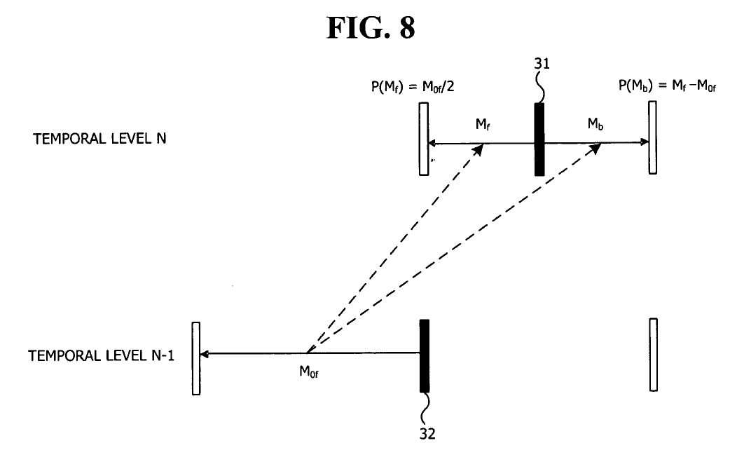

FIG. 8 illustrates a case where a base frame has only a forward motion vector M_{0f}. Prediction motion vectors P(M_{f}) and P(M_{b}) corresponding to M_{f} and M_{b} of the current frame 31 may be obtained by Equation 1.

Exemplary embodiments of FIGS. 5 through 8 assume a case where a reference distance (a temporal distance between a certain frame and its reference frame, and a POC difference) of a base frame motion vector is twice a reference distance of the current frame, but this is not always the case. Accordingly, this is only a general assumption made for this case.

The prediction motion vector P(M_{f}) corresponding to the forward motion vector M_{f} of the current frame may be obtained by multiplying a reference distance coefficient d to a motion vector M₀ of the base frame. The reference distance coefficient “d” has both a sign and a size (magnitude). The size is a value of a reference distance of the current frame divided by a reference distance of the base frame. When the reference directions are the same, the reference distance coefficient “d” has a positive sign. When the reference directions are different, the reference distance coefficient “d” has a negative sign.

The prediction motion vector P(M_{b}) corresponding to the backward motion vector M_{b} of the current frame may be obtained by subtracting the base frame motion vector from M_{f} of the current frame when the base frame motion vector is a forward motion vector. Conversely, the prediction motion vector P(M_{b}) corresponding to the backward motion vector M_{b} of the current frame may be obtained by adding the base frame motion vector to M_{f} of the current frame when the base frame motion vector is a backward motion vector.

FIGS. 5 through 8 explained various cases where a current frame motion vector is predicted using a base frame motion vector. However, POC of the low temporal level (e.g., frame 32) and POC of the high temporal level (e.g., frame 31) are not identical; therefore, a problem lies in that motion vectors located in which positions should be matched with each other in a single frame. The problem can be solved by the following.

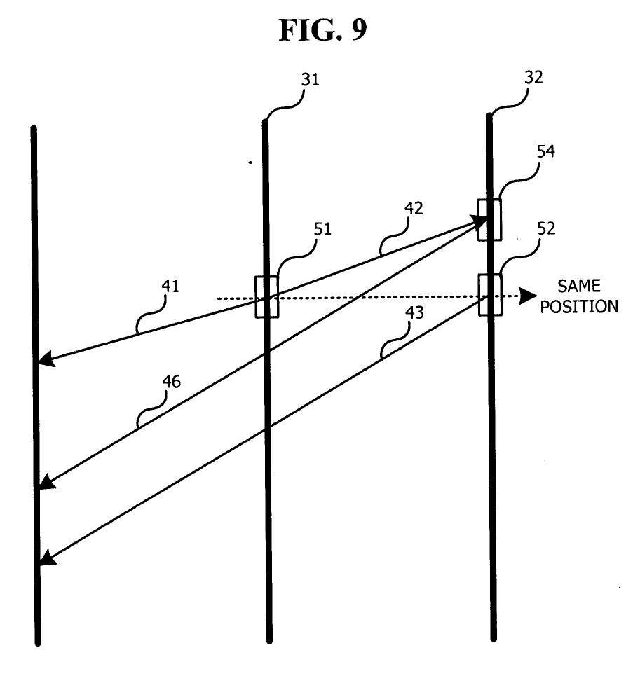

To solve this problem, motion vectors located in the same position are matched with each other. Referring to FIG. 9, a motion vector 43 allocated to a block 52 in a base frame 32 is used to predict motion vectors 41 and 42 allocated to a block 51 that is located in a position where the block 52 is located, but a difference may occur because of a time difference between the frames.

As a more specific solution, a motion vector is predicted after correcting different temporal positions. In FIG. 9, an area 54, corresponding to a backward motion vector 42 of a block 51 in a current frame 31, is found in a base frame 32. Then a motion vector 46 of the area 54 is used to predict motion vectors 41 and 42 of the current frame 31. A macroblock pattern of the area 54 is different from that of the block 51, but may be solved using a method of obtaining an area weight average or a median value.

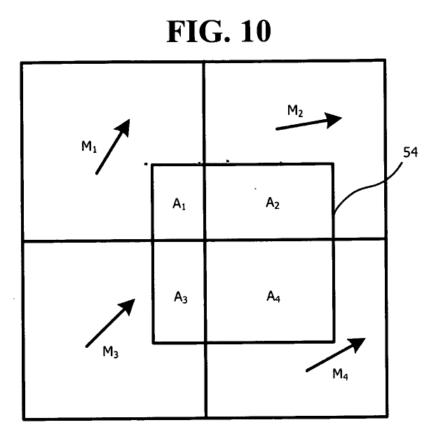

When the area 54 lies on a position where four blocks cross over as illustrated in FIG. 10, a motion vector M of the area 54 may be obtained using Equation 5 if the area weight average is used, or using Equation 6 if the median value is used. In a case of the bi-directional reference, since each block has two motion vectors, the operation is performed for each motion vector. In Equations 5 and 6, “i” may be an integer in the range of 1 to 4.

$$\begin{matrix}M = \frac{{\sum }_{i = 1}^{4} {A}_{i} \times {M}_{i}}{{\sum }_{i = 1}^{4} {A}_{i}} & ( 5 ) \\ M = median ( {M}_{i} ) & ( 6 )\end{matrix}$$

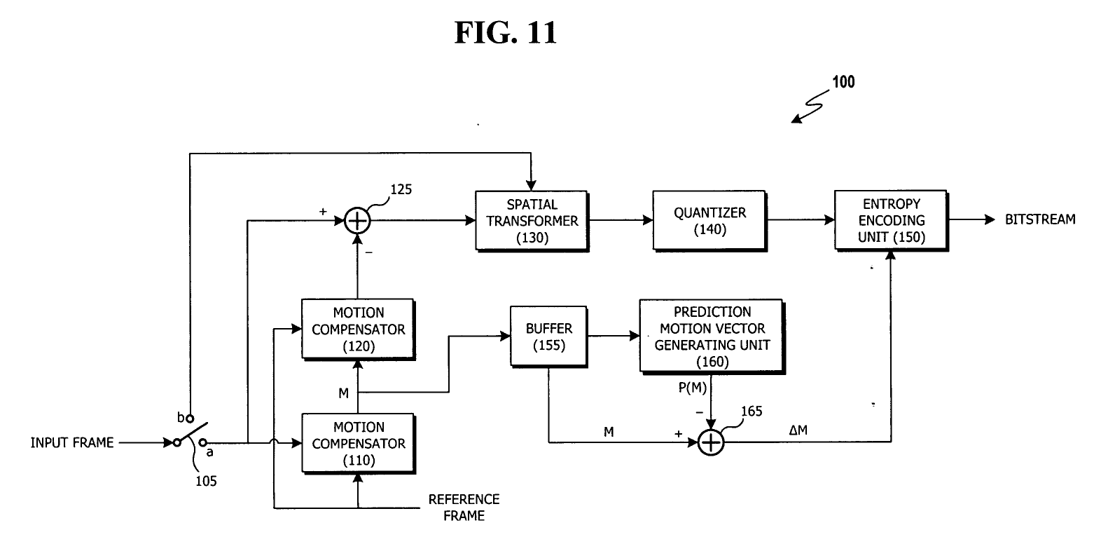

Hereinafter, a construction of a video encoder and a video decoder will be described. FIG. 11 is a block diagram illustrating a construction of a video encoder 100 according to an exemplary embodiment of the present invention.

The input frame is input to a switch 105. When the switch 105 is switched on “b” in order to code the input frame as a low frequency frame, the input frame is directly provided to a spatial transformer 130. On the other hand, when the switch 105 is switched on “a” in order to code the input frame as a high frequency frame, the input frame is directly input to a motion estimator 110 and a subtractor 125.

The motion estimator 110 performs a motion estimation for the input frame with reference to a reference frame (a frame located in a different temporal position), and obtains a motion vector. As the reference frame, an unquantized input frame may be used in an open-loop method, and a quantized input frame and a frame reconstructed by reverse-quantizing the input frame in a closed-loop method.

Generally, an algorithm widely used for the motion estimation is a block matching algorithm. This block matching algorithm estimates a displacement that corresponds to the minimum error of a motion vector moving a given motion block in the unit of a pixel or a subpixel (i.e., ½ pixel or ¼ pixel) in a specified search area of the reference frame. The motion estimation may be performed using a motion block of a fixed size or using a motion block having a variable size according to the hierarchical variable size block matching (HVSBM) used in H.264. When HVSBM is used, a motion vector as well as a macroblock pattern is transmitted to the video decoder.

The motion compensator 120 performs motion compensation on the reference frame using the motion vector M obtained from the motion estimator 110, and generates a prediction frame. In a case of one-directional reference (forward or backward), the motion-compensated frame may be the prediction frame. In a case of bi-directional reference, an average of two motion-compensated frames may be the prediction frame.

The subtractor 125 subtracts the generated prediction frame from the current input frame.

The spatial transformer 130 performs spatial transform on the input frame provided by the switch 105 or the calculated result of the subtractor 125 to create a transform coefficient. The spatial transform method may include the Discrete Cosine Transform (DCT) or the wavelet transform. Specifically, DCT coefficients are created in the case where DCT is employed, and wavelet coefficients are created in the case where wavelet transform is employed.

A quantizer 140 quantizes the transform coefficient received from the spatial transformer 130. Quantization means the process of expressing the transform coefficients formed in arbitrary real values by discrete values, and matching the discrete values with indices according to the predetermined quantization table. The quantized result value is referred to as a quantized coefficient.

The motion vector M generated by the motion estimator 110 is temporarily stored in a buffer 155. When the motion vector M of the current frame is stored in the buffer 155, motion vectors of lower temporal levels have already been stored because the buffer 155 stores motion vectors generated by the motion estimator 110.

The prediction motion vector generator 160 generates a prediction motion vector P(M) of the current frame based on the motion vectors of the lower temporal level that were generated in advance and stored in the buffer 155. If the current frame has a forward and backward motion vector, two prediction motion vectors are generated.

The prediction motion vector generator 160 selects a base frame for the current frame. The base frame is a frame that has a smallest POC difference, i.e., a temporal distance between the frame and the current frame, of high frequency frames of the low temporal level. Then the prediction motion vector generator 160 calculates a prediction motion vector P(M) of the current frame using the base frame motion vector. The detailed process of calculating the prediction motion vector p(M) was described with reference to Equations 1 through 6.

The subtractor 165 subtracts the calculated prediction motion vector P(M) from the motion vector M of the current frame. A motion vector difference ΔM generated in the subtracted result is provided to an entropy coding unit 150.

The entropy coding unit 150 losslessly encodes the motion vector difference ΔM provided by the subtractor 165 and the quantization coefficient provided by the quantizer 140 into a bitstream. There are a variety of lossless coding methods including Huffman coding, arithmetic coding, variable length coding, and others.

The compression by expressing a motion vector of the current frame as a difference through motion prediction was described with reference to FIG. 11. To reduce the amount of bits consumed by motion vectors, the current frame motion vector may be replaced as a prediction motion vector. In this case, there is no data, which will be transmitted to the video decoder layer, for expressing the current layer motion vector.

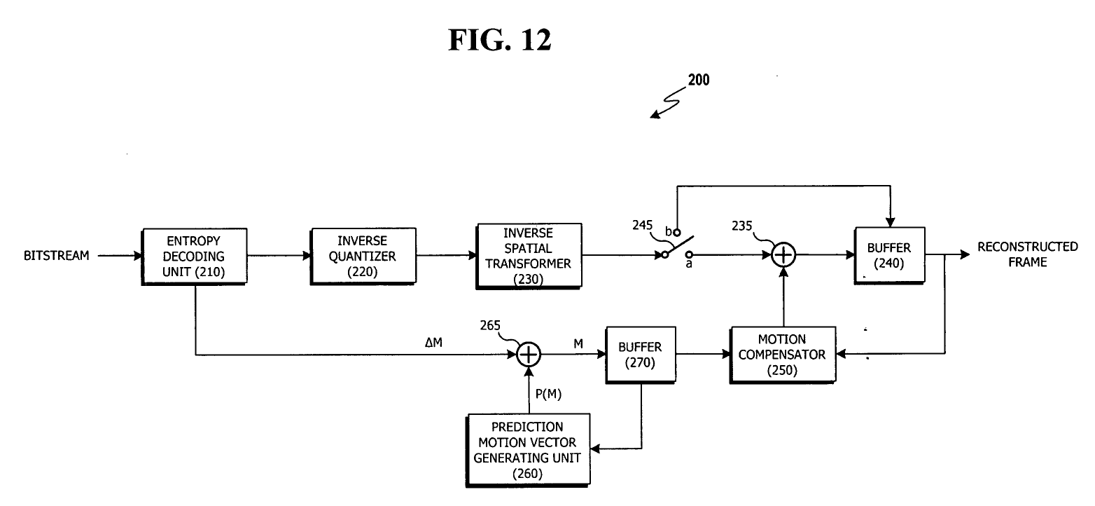

FIG. 12 is a block diagram illustrating a construction of a video decoder 200 according to an exemplary embodiment of the present invention.

An entropy decoding unit 210 losslessly decodes a bitstream to extract motion data and texture data. The motion data is the motion vector difference ΔM generated by the video encoder 100.

The extracted texture data is provided to an inverse quantizer 220. The motion vector difference ΔM is provided to an adder 265.

The prediction motion vector generator 260 generates a prediction motion vector P(M) of the current frame based on the motion vectors of the lower temporal level that were generated in advance and stored in the buffer 270. If the current frame has a forward and backward motion vector, two prediction motion vectors are generated.

The prediction motion vector generator 260 selects a base frame for the current frame. The base frame is a frame that has a smallest POC difference, i.e., a temporal distance between the frame and the current frame, of high frequency frames of low temporal level. Then the prediction motion vector generator 260 calculates a prediction motion vector P(M) of the current frame using the base frame motion vector. The detailed process of calculating the prediction motion vector P(M) was described with reference to Equations 1 through 6.

The adder 265 reconstructs the current frame motion vector M by adding the calculated prediction motion vector P(M) to the motion vector difference ΔM. The reconstructed motion vector M is temporally stored in the buffer 270, and may be used to reconstruct another motion vector.

An inverse quantizer 220 inversely quantizes the texture data provided by the entropy decoding unit. Inverse quantization is the process of reconstructing values from corresponding quantization indices created during a quantization process using the quantization table used during the quantization process.

An inverse spatial transformer 230 performs inverse spatial transform on the inversely quantized result. The inverse spatial transform is the inverse process of the spatial transform performed by the spatial transformer 130 of FIG. 11. Inverse DCT or inverse wavelet transform may be used for the inverse spatial transform. The inverse spatial transformed result, i.e., the reconstructed low frequency frame or the reconstructed high frequency frame, is provided to a switch 245.

When a low frequency frame is input, the switch 245 provides the low frequency frame to the buffer 240 by switching on “b”. When a high frequency frame is input, the switch 245 provides the high frequency frame to an adder 235 by switching on “a”.

The motion compensator 250 performs a motion estimation for the current frame with reference to a reference frame (which is reconstructed in advance and stored in the buffer 270) using the current frame motion vector M provided by the buffer 270, and generates a prediction frame. In a case of one-directional reference (forward or backward), the motion-compensated frame may be the prediction frame. In a case of bi-directional reference, an average of two motion-compensated frames may be the prediction frame.

The adder 235 reconstructs the current frame by adding the generated prediction frame to the high frequency frame provided by the switch 245. The reconstructed current frame is temporally stored in the buffer 240, and may be used to reconstruct another frame.

The process of reconstructing the current frame motion vector from the motion vector difference of the current frame was described with reference to FIG. 12. In a case where the motion vector difference is not transmitted by the video encoder, the current frame motion vector may be used as the prediction motion vector.

The components shown in FIGS. 11 and 12 may be implemented in software such as a task, class, sub-routine, process, object, execution thread or program, which is performed on a certain memory area, and/or hardware such as a Field Programmable Gate Array (FPGA) or an Application Specific Integrated Circuit (ASIC). The components may also be implemented as a combination of software and hardware. Further, the components may advantageously be configured to reside in computer-readable storage media, or to execute on one or more processors.

As described above, exemplary embodiments of the present invention can more efficiently compress a motion vector of an unsynchronized frame.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of compressing a motion vector in a temporal decomposition having multiple temporal levels, the method comprising:
selecting a second frame that exists in a low temporal level of a first frame and is nearest to the first frame, where the first frame exists in a current temporal level of the multiple temporal levels;
generating a prediction motion vector for the first frame from a motion vector of the second frame; and
subtracting the generated prediction motion vector from the motion vector of the first frame.

2. The method of claim 1, further comprising losslessly encoding the subtracted result.

3. The method of claim 1, wherein the temporal distance is determined by a picture order count (POC) of the corresponding frame.

4. The method of claim 3, wherein if the first frame POC is smaller than the second frame POC, the second frame motion vector that is used to generate the prediction motion vector is a backward motion vector.

5. The method of claim 4, wherein if the prediction motion vector is for a forward motion vector of the first frame, the prediction motion vector is (−½) times of the second frame motion vector.

6. The method of claim 4, wherein if the prediction motion vector is for a backward motion vector of the first frame, the prediction motion vector is the sum of the forward motion vector of the first frame and the backward motion vector of the second frame.

7. The method of claim 3, wherein if the first frame POC is larger than the second frame POC, the second frame motion vector that is used to generate the prediction motion vector is a forward motion vector.

8. The method of claim 7, wherein if the prediction motion vector is for a forward motion vector of the first frame, the prediction motion vector is (−½) times of the second frame motion vector.

9. The method of claim 4, wherein if the prediction motion vector is for a backward motion vector of the first frame, the prediction motion vector is the sum of the forward motion vector of the first frame and the backward motion vector of the second frame.

10. A method of compressing a motion vector in a temporal composition having multiple temporal levels, the method comprising:
extracting motion data on a first frame that exists in a current temporal level of the multiple temporal levels from an input bitstream;
selecting a second frame that exists in a low temporal level of the first frame and is nearest to the first frame;
generating a prediction motion vector for the first frame from a motion vector of the second frame; and
adding the generated prediction motion vector to the motion data.

11. The method of claim 10, wherein the temporal distance is determined by a picture order count (POC) of the corresponding frame.

12. The method of claim 11, wherein if the first frame POC is smaller than the second frame POC, the second frame motion vector that is used to generate the prediction motion vector is a backward motion vector.

13. The method of claim 11, wherein if the prediction motion vector is for a forward motion vector of the first frame, the prediction motion vector is (−½) of the second frame motion vector.

14. The method of claim 12, wherein if the prediction motion vector is for a backward motion vector of the first frame, the prediction motion vector is the sum of the forward motion vector of the first frame and the backward motion vector of the second frame.

15. The method of claim 11, wherein if the first frame POC is bigger than the second frame POC, the second frame motion vector that is used to generate the prediction motion vector is a forward motion vector.

16. The method of claim 15, wherein if the prediction motion vector is for a forward motion vector of the first frame, the prediction motion vector is (−½) of the second frame motion vector.

17. The method of claim 15, wherein if the prediction motion vector is for a backward motion vector of the first frame, the prediction motion vector is the sum of the forward motion vector of the first frame and the backward motion vector of the second frame.

18. An apparatus for compressing a motion vector in a temporal decomposition having multiple temporal levels, the apparatus comprising:
means for selecting a second frame which exists in a low temporal level of a first frame and is nearest to the first frame, where the first frame exists in a current temporal level of the multiple temporal levels;
means for generating a prediction motion vector for the first frame from a motion vector of the second frame; and
means for subtracting the generated prediction motion vector from the motion vector of the first frame.

19. An apparatus for compressing a motion vector in a temporal composition having multiple temporal levels, the apparatus comprising:
means for extracting motion data on a first frame which exists in a current temporal level of the multiple temporal levels from an input bitstream;
means for selecting a second frame which exists in a low temporal level of the first frame and is nearest to the first frame;
means for generating a prediction motion vector for the first frame from a motion vector of the second frame; and
means for adding the generated prediction motion vector to the motion data.
